(19) United States
(12) Patent Application Publication
(10) Pub. No.: US 2002/0174942 A1
(43) Pub. Date: Nov. 28, 2002

(54) Method and apparatus for manufacturing a flexible curtain

(76) Inventors: Willis Jay Mullet, Gulf Breeze, FL (US); Donald Bruce Kyle, Pace, FL (US); Kelly Ray Green, Pace, FL (US); Harry Edward Asbury, Gulf Breeze, FL (US)

Correspondence Address: Kenneth L. Mitchell, Woodling, Krost and rust, 9213 Chillicothe Road, Kirtland, OH, 44094, US

(21) Appl. No.: 10/161,494

(22) Filed: May 30, 2002

Related U.S. Application Data
(62) Division of application No. 09/644,926, filed on Aug. 23, 2000.

(51) Int. Cl. B31F 1/00

(52) U.S. Cl. 156/204; 156/226; 156/222

(57) ABSTRACT

A method and apparatus for manufacturing a flexible curtain as disclosed and claimed. Edges of a polymeric material are folded back on themselves. A portion of the edges are secured and a portion is left unsecured or free. The flexible curtain is used in a windlocking apparatus to prevent the unwanted intrusion of wind, water and debris into a building opening. The free, or unsecured flap of the folded edge absorbs shock associated with storm disturbances. Edge rollers are used to laminate the edges of the curtains selectively such that only a portion of the edge is secured leaving the flap unsecured. Stitching, ultrasonic welding and gluing are alternative ways and/or additional ways of providing for the securement of a portion of the edge to itself. Perforations are made in the secured portion of the folded edge.

This is a divisional patent application of co-pending patent application Ser. No. 09/644,926, filed Aug. 23, 2000.

### FIELD OF THE INVENTION

This invention is a method and apparatus for making a windlocking curtain.

### BACKGROUND OF THE INVENTION

During hurricanes and other high wind velocity storms, the breach of a building opening can cause great damage to the structure. We have U.S. Pat. No. 6,296,039B1 which addresses the use of the windlocking curtain in storm conditions. This invention discloses and claims the method and apparatus for making the windlocking curtain.

### SUMMARY OF THE INVENTION

A method for manufacturing a three-ply flexible curtain is disclosed. Two of the plys are polymeric and one is a woven substrate which resides between the two polymeric plies. A first and second laminating roll under the force of pressure and heat secures the three plys together. A plurality of beveled rollers fold the edges of the three ply construction back upon itself.

A first and second edge roller are used to laminate the folded edge to itself. The second edge roller has a notch which limits the extent of the lamination because the notched area on the second edge roller does not allow compression of the folded edge. Lack of compression of the folded edge in the notched area results in a loose flap which is useful in the application of the flexible curtain for absorbing shock during transient (storm) conditions. Alternatively, and/or additionally, the secured portion of the folded edge may be glued, stitched or welded.

Perforations are made in the folded edges of the curtain. Rotary, stationary or indexing punches and dies may be used.

It is an object of this invention to produce a flexible curtain having a folded edge which is partially secured to itself and which is partially unsecured.

It is a further object of this invention to produce a flexible curtain having a folded edge which has perforations therethrough where the edge is partially secured to itself.

It is a further object of this invention to produce a flexible curtain having a folded edge which has a loose, or free, flap capable of absorbing energy.

It is a further object of this invention to use a first edge roller and a second edge roller to partially laminate the folded edges of the flexible curtain.

It is a further object of this invention to fold the edges of a flexible curtain so that they may be partially laminated, glued, stitched or welded together.

It is a further object of this invention to laminate two plys of polymeric material to a woven substrate residing therebetween.

Other objects of this invention will become apparent when the drawing figures, the description of the invention and the claims are considered which follow hereinbelow.

### BRIEF DESCRIPTION OF THE DRAWINGS

FIG. 1 is a perspective view of the invention illustrating, among other things, the laminating rollers, the edge rollers, and the perforating rollers.

FIG. 1A is a perspective view similar to FIG. 1 without the stitching apparatus.

FIG. 1B is a partial cross-sectional view of the flexible curtain illustrating a folded edge.

FIG. 2 is a view illustrating much of the same structure as FIG. 1 only supports are not shown in this view.

FIG. 3 is an enlarged portion of FIG. 2.

FIG. 3A is an illustration of one edge of the curtain between the first edge roller and the second edge roller. FIG. 3A also illustrates the notch in the second roller.

FIG. 4 is another embodiment of the invention illustrating strips applied to the edges of the curtain.

FIG. 4A is another embodiment of the invention illustrating ultrasonic welding of the strip to the edge of the curtain.

FIG. 5 is an enlargement of a portion of FIG. 4A.

FIG. 6 is an enlargement of a portion of FIG. 1 illustrating a rotary punch and die for perforating the folded edges of the flexible curtain 128.

FIG. 7 is an enlargement of a portion of FIG. 6 better illustrating the perforations in the folded edges.

FIG. 8 is an enlargement of a portion of FIG. 1 illustrating the stitching apparatus.

FIG. 9 is a flow chart of a stationary punching system.

FIG. 10 illustrates a punch and a die in cross section.

FIG. 11 illustrates the punch and die of FIG. 10 in perspective.

FIG. 12 is a perspective view of the punch and die shown together with the curtain.

A better understanding of the invention will be had when reference is made to the description of the invention and the claims which follow hereinbelow.

### DESCRIPTION OF THE INVENTION

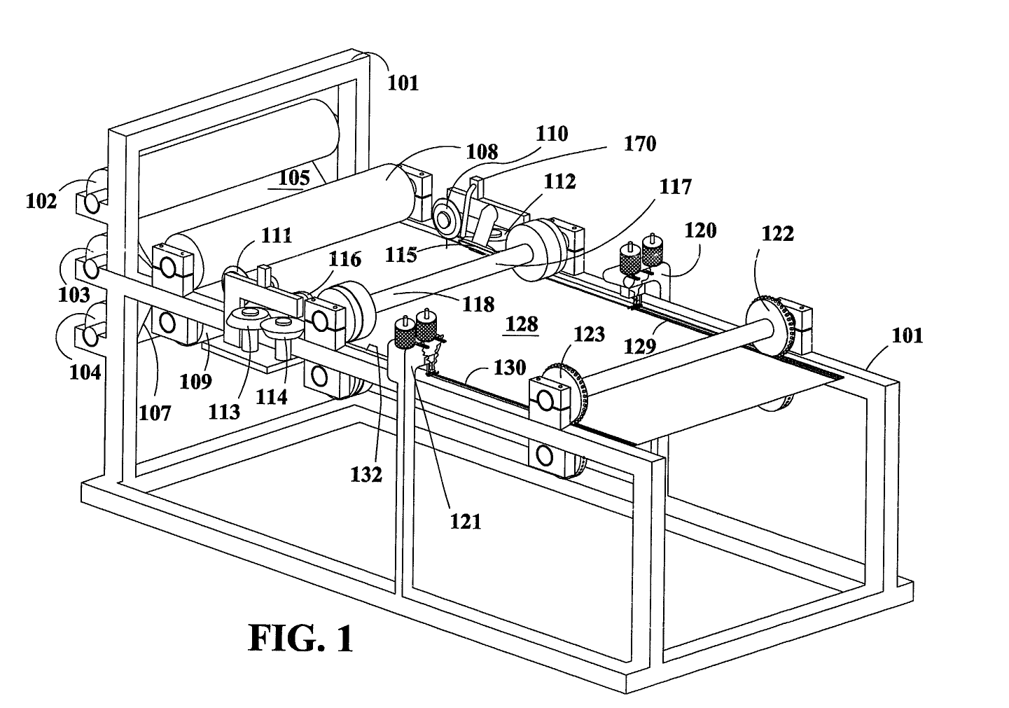

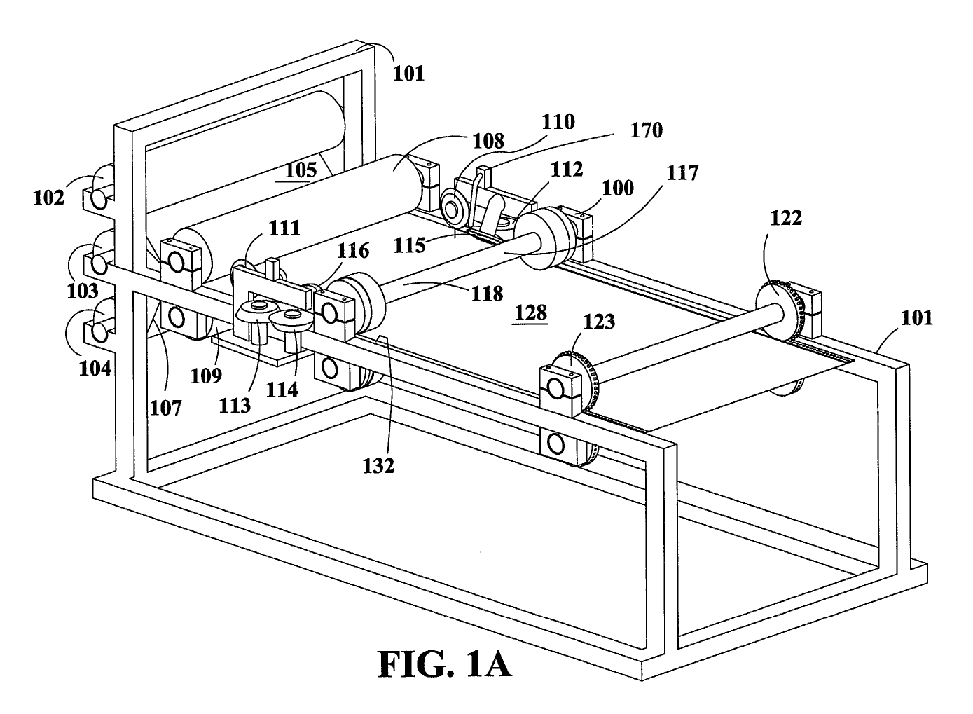

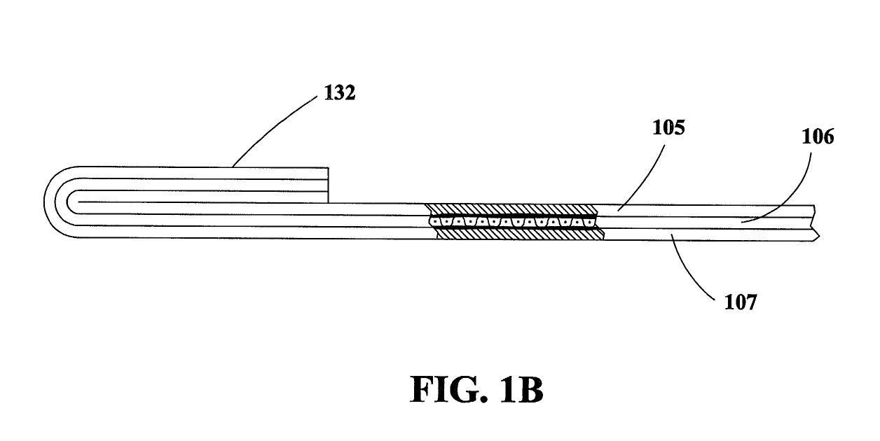

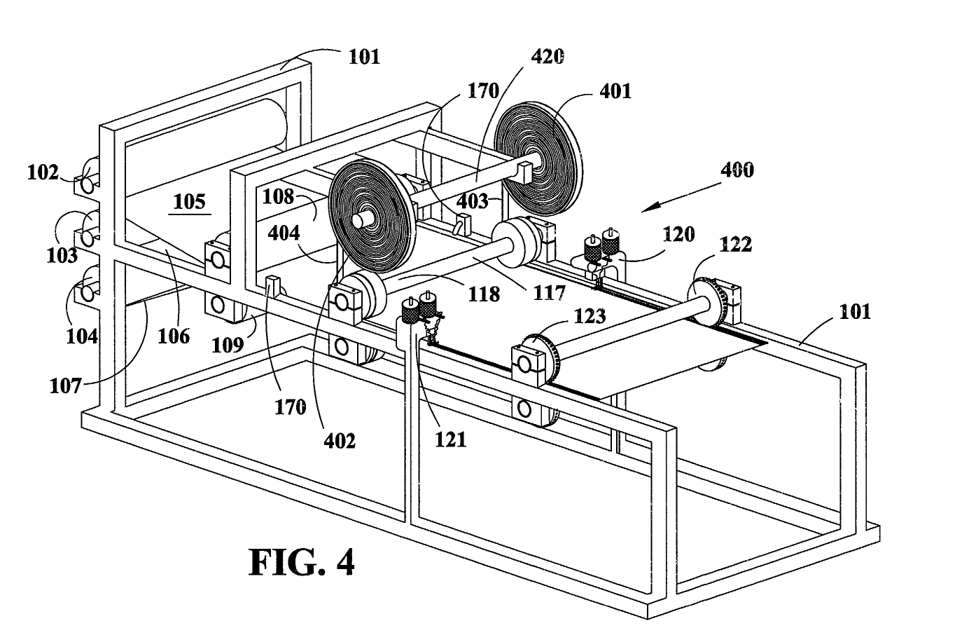

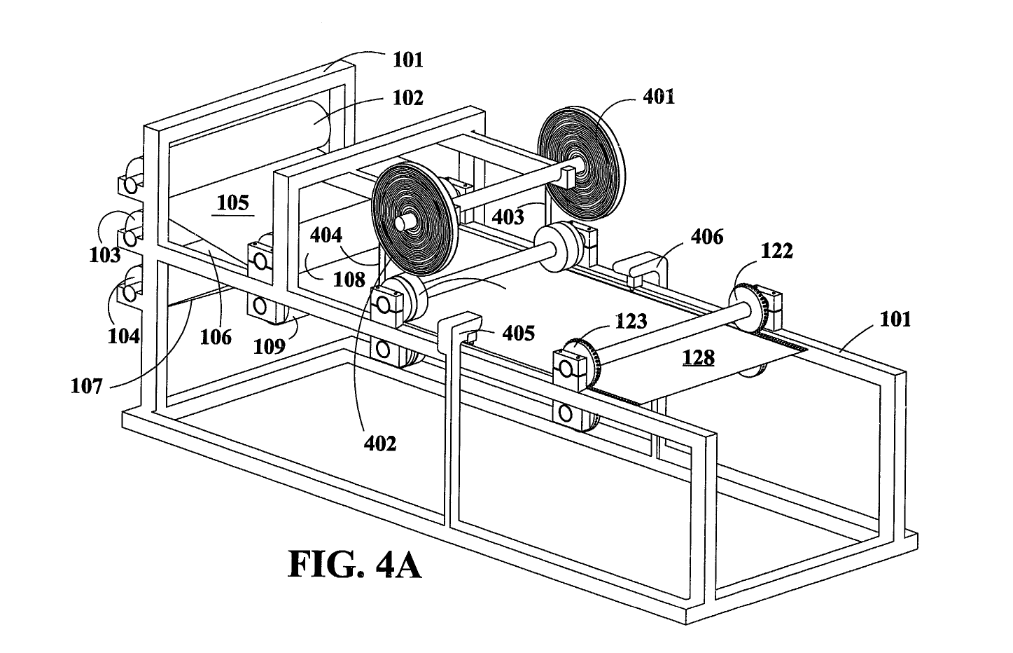

FIG. 1 is a perspective view of the invention illustrating, among other things, the laminating rollers 108, 109 the edge rollers and the perforating rollers. FIG. 1A is a perspective view similar to FIG. 1 without the stitching apparatus 120, 121. The stitching apparatus 120, 121 shown in FIG. 1 ensures that the folded edge 132 is affixed completely to the flexible curtain 128. Lamination alone of the edge 132 to the flexible curtain 128 is sufficient to attach the edge to the curtain. Stitching 120, 121, gluing 170 or welding 405, 406 (see, FIG. 4A) are additional methods of ensuring that the folded edge 132 is completely affixed to the flexible curtain.

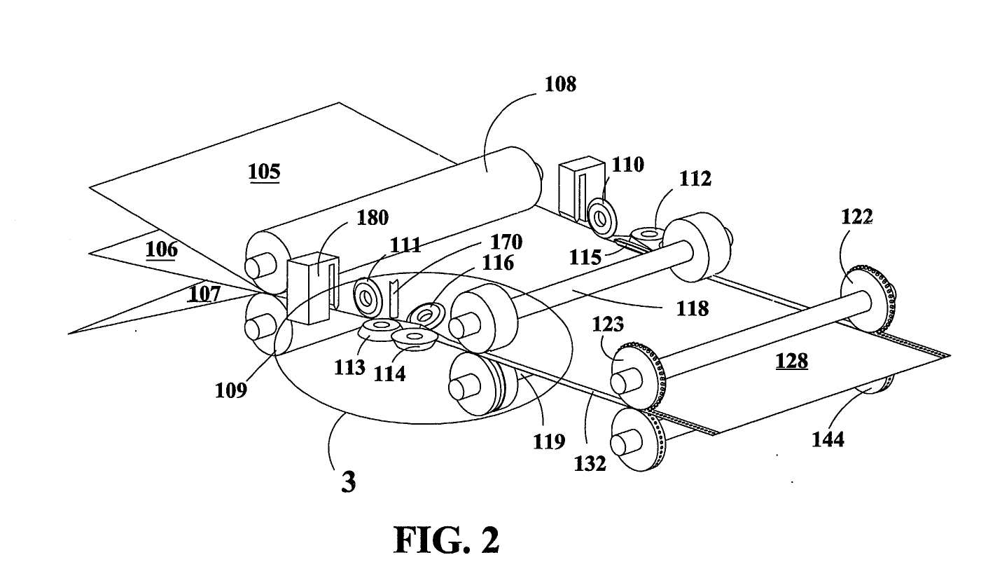

Referring to FIGS. 1 and 1A, reference numeral 101 represents the frame which positions the equipment for performing the method. First roll 102 has first polymeric material 105 wound therearound. Second roll 103 has woven sheet 106 wound therearound. Third roll 104 has second polymeric material 107 wound therearound. First and second polymeric sheets 105, 107 are laminated to the woven sheet 106 and to each other by the first laminating roll 108 and the second laminating roll 109. The three sheets 105, 106 and 107 are best viewed in FIG. 2 which is a view illustrating much of the same structure as FIG. 1 only the supporting frame 101 and structure are not shown. FIG. 2 also illustrates a slitter 180 which controls the width of the laminated curtain prior to folding of the edges.

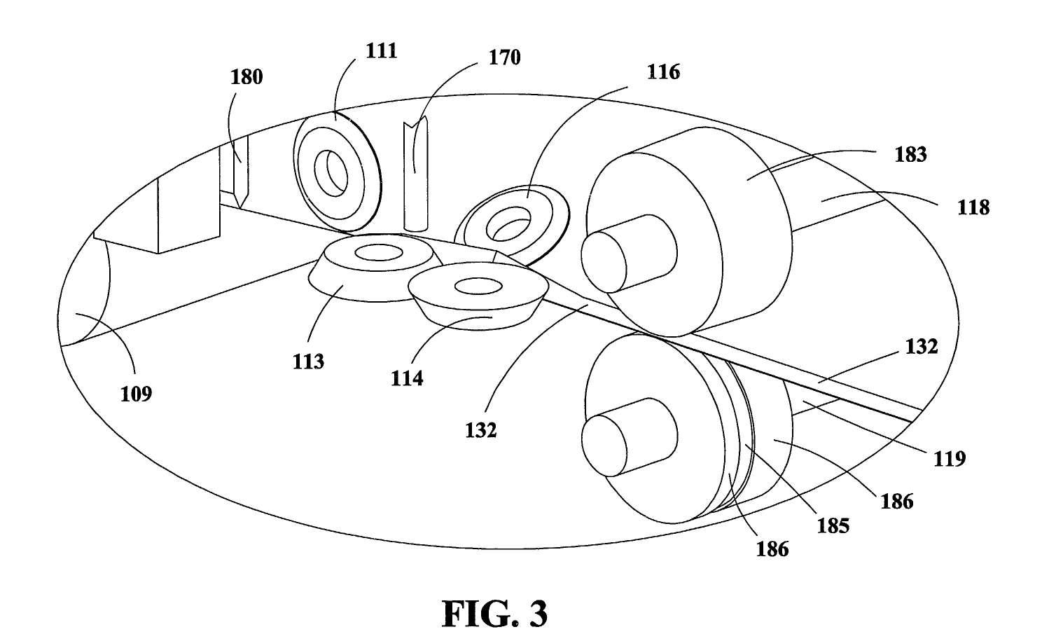

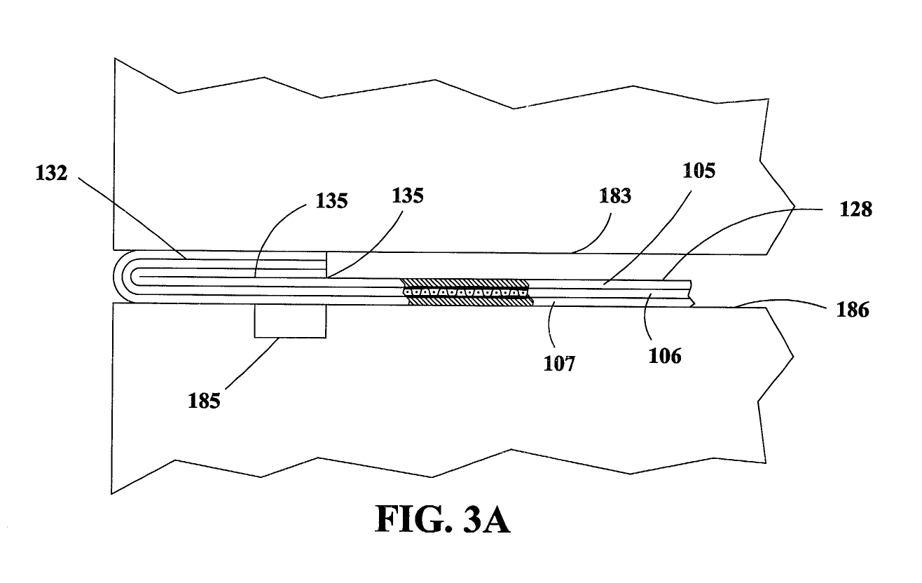

Referring to FIG. 3, which is an enlarged portion of FIG. 2, one set of beveled rollers 111 (first), 113 (second), 114 (third) and 116 (fourth) are illustrated. The other set of beveled rollers 110, 112, 113 are also viewed in FIGS. 1, 1A and 2. There are four beveled rollers on the far side but only three are visible in these perspective views.

Referring to FIGS. 2 and 3, first beveled roller 111 and second beveled roller 113 begin to turn the edge of the flexible curtain 128 vertically upward. Third beveled roller 116 in combination with second beveled roller 113 begin to fold the flexible curtain inwardly on itself. Fourth beveled roller 114 completes the fold. Although the flexible curtain is folded leaving fourth beveled roller 114, it is not laminated upon itself at this point. Fig. 1B is an illustration of the curtain and an edge 132 folded upon itself but not laminated.

Folded edge 132 next passes through first edge roller 118 and second edge roller 119. Referring to FIGS. 3 and 3A, first edge roller 118 includes an enlarged end portion 183 which is cylindrically shaped and has a constant diameter. Second edge roller 119 includes an enlarged edge portion 186 which is cylindrically shaped and has a circumferential notch therein. Circumferential notch 185 is a circumferential notch in cylindrical end portion 186 of edge roller 119. As folded edge 132 passes through end portions 183 and 186 of edge rollers 118, 119 it is compressed and laminated except for the portion proximal to notch 185. The function of the circumferential notch 185 is to prevent lamination of the folded edge portion 132 of the flexible curtain proximal (i.e. near) the notch. Reference numeral 135 indicates the extent of the folded edge 132 which is not laminated. See, FIG. 3A.

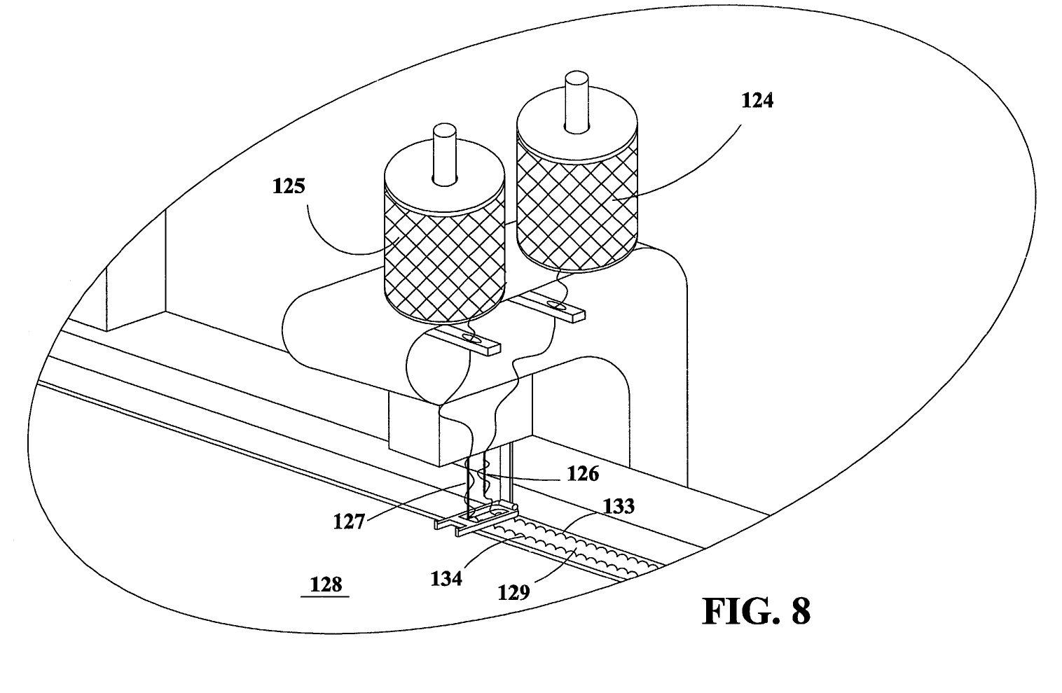

FIG. 1A represents the preferred embodiment of the invention. Stitching apparatus 120, 121 may be employed to reinforce the attachment of the folded edge 132 to the flexible curtain 128. A stitching apparatus 120 can be seen in more detail by referring to FIG. 8, an enlargement of a portion of FIG. 1. FIG. 8 illustrates thread 124, 125 needles 126, 127, and stitching 133, 134. Another method of reinforcing the bond between the folded edge 132 and the flexible curtain 128 is to apply adhesive with an applicator 170 prior to completion of the folding of the edge as best seen in FIGS. 1, 2 and 3. Still referring to FIG. 8, reference numeral 129 indicates the area of the folded edge secured by the stitching. Referring to FIG. 1, stitching is indicated by reference numerals 129 and 130. Stitching may be used in addition to lamination. When the flexible curtain produced by this invention is used to protect building openings, great force will be exerted on the portion of the folded edge secured to itself. Redundant securement of the folded edge can also be effected by ultrasonic welding 405, 406 (FIG. 4A).

FIG. 4 is another embodiment of the invention illustrating polymeric strips 403, 404 applied to the edges of the curtain. Polymeric strips 403, 404 are coiled up on a spindle 420 and are dispensed therefrom and laminated by edge rollers 118, 119. Additionally, the strips may be stitched with stitching apparatus 120, 121 (FIG. 4) or ultrasonically welded 405, 406 (FIG. 4A). FIG. 5 is an enlargement of a portion of FIGS. 4 and 4A and better illustrates the lamination of the strips 403, 404 to the three ply flexible curtain 128.

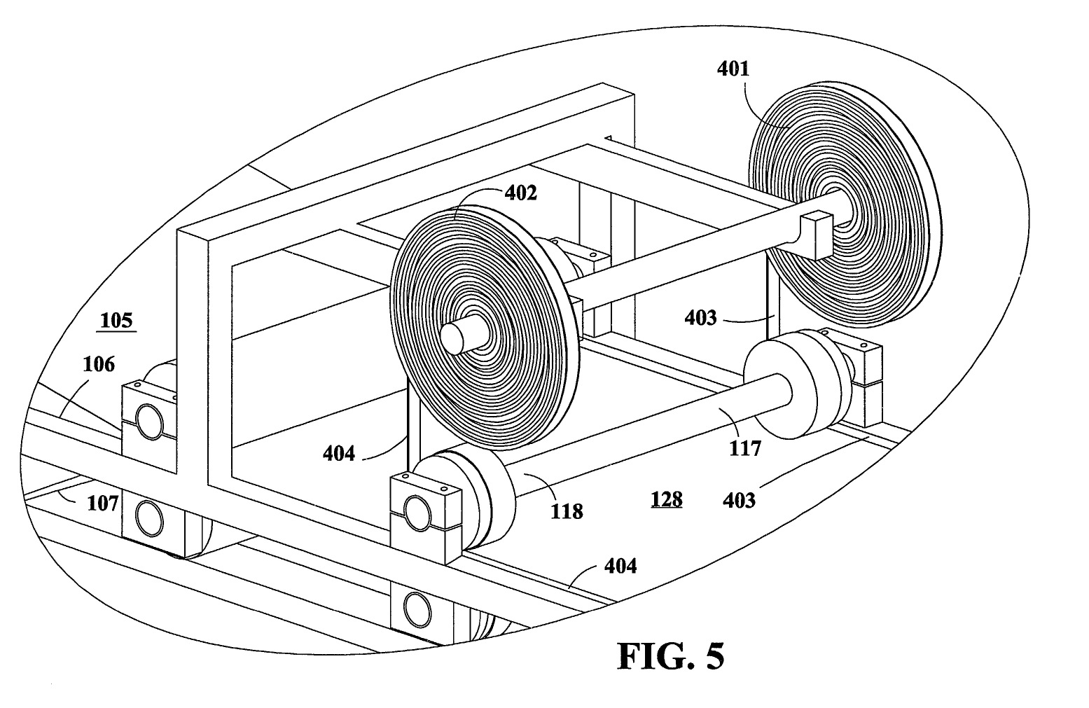

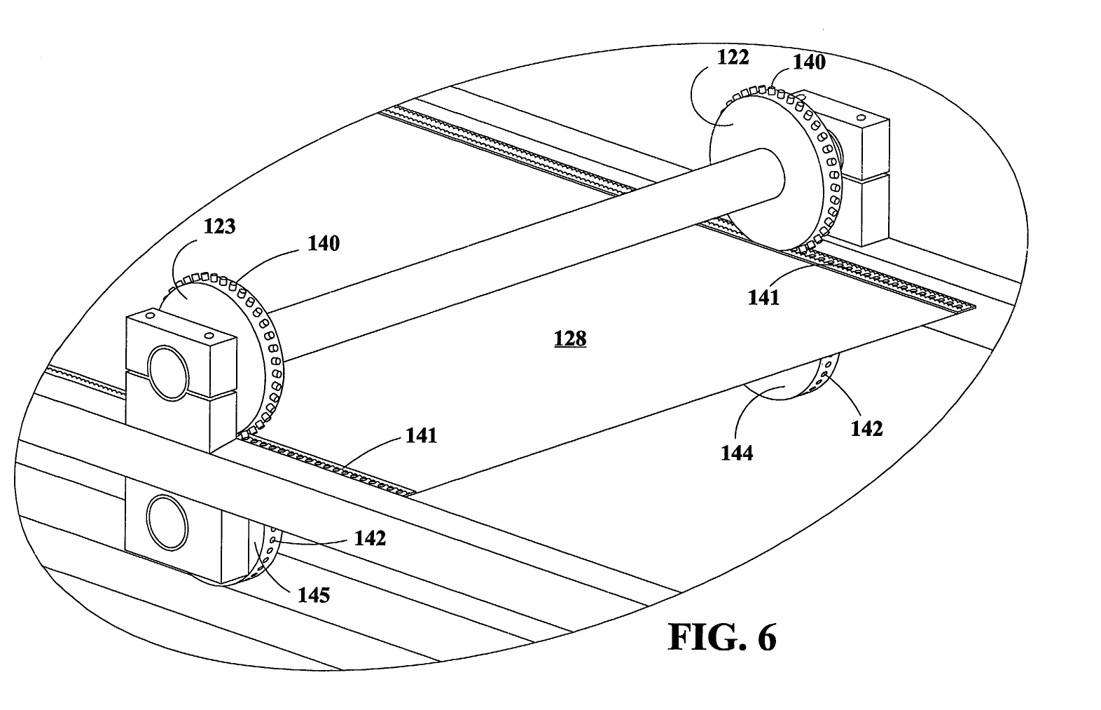

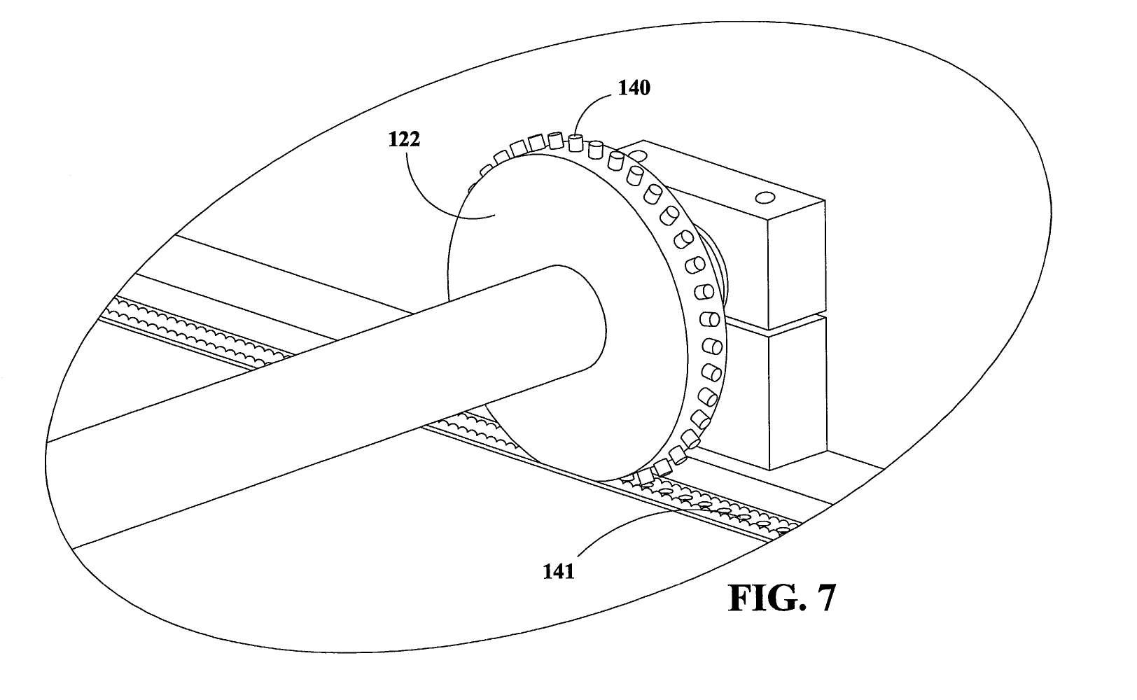

FIG. 6 is an enlargement of a portion of FIG. 1 and illustrates the first perforating rollers 122, 123 with protrusions 140 therein. Sometimes herein the perforating rollers 122, 123 are referred to as rotary punches. Reciprocating rollers 144, 145 have apertures or dies 142 therein which receive the protrusions 140 together with the polymeric material which has been punched out. Protrusions 140 and dies 142 are preferably cylindrical but other shapes may be used. By punched out it is meant perforated as indicated by the perforations 141 in FIG. 7. FIG. 7 is an enlargement of a portion of FIG. 6. The punched out material exits the die through passageways (not shown in the drawings). The rotary dies can be driven by a motor if desired.

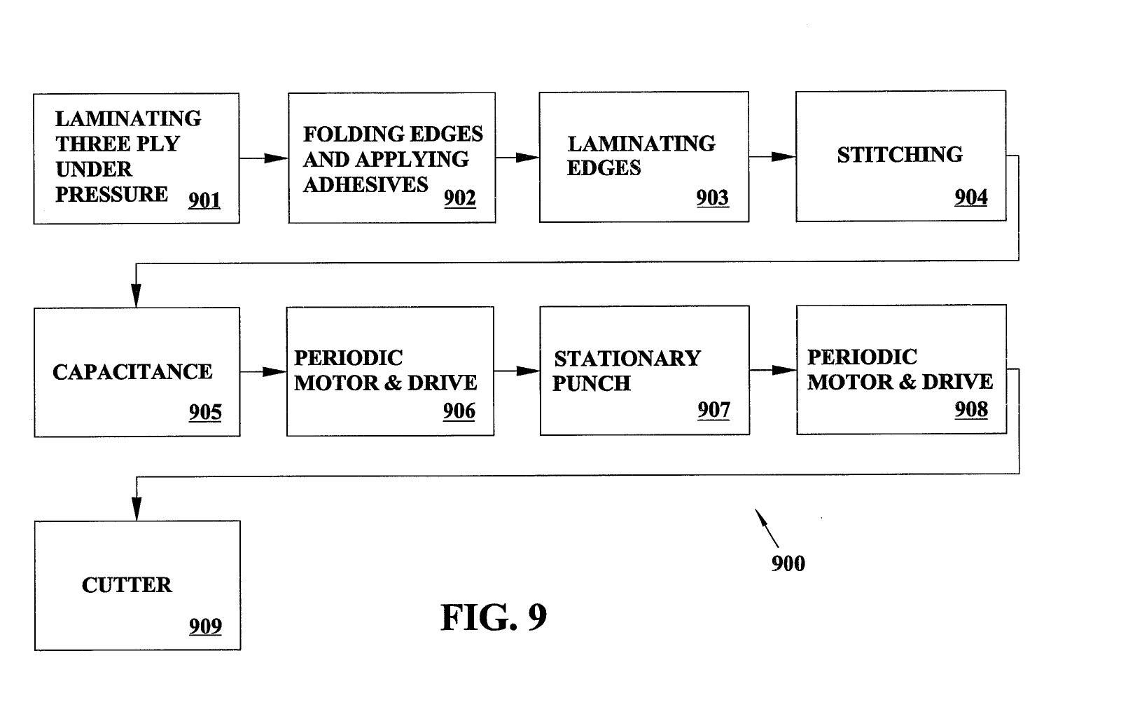

Alternatively, the flexible curtain may be driven by a motor 906 and may include a capacitance station 905 if stationary punching is desired. See, FIG. 9, an embodiment of the invention set out in diagrammatic form and represented generally by the reference numeral 900. This embodiment discloses a drive system and a stationary punch. A three ply polymeric flexible curtain is laminated initially in the first step 901. Edges are folded and adhesive is applied in the next step 902. Those edges are laminated 903 and 5 additionally may be stitched 904. A capacitance station 905, sometimes referred to herein as a surge station, may be used if a stationary punch is employed. A first periodic motor and drive 906 feeds the stationary punch 907. A second periodic motor and drive 908 is synchronized to the first periodic motor and drive 906 and feeds a cutter 909 which cuts the flexible curtain into usable lengths.

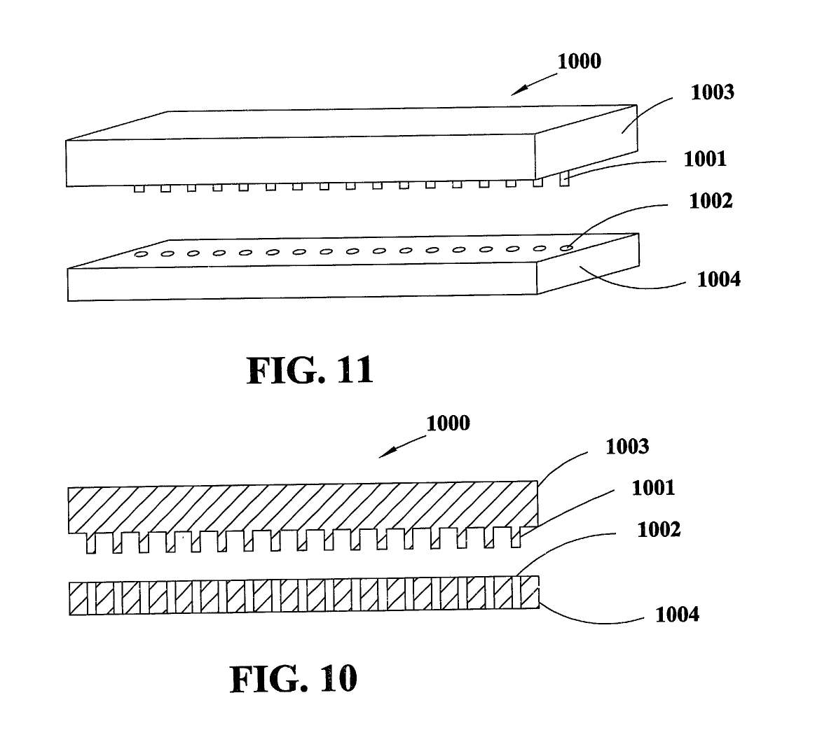

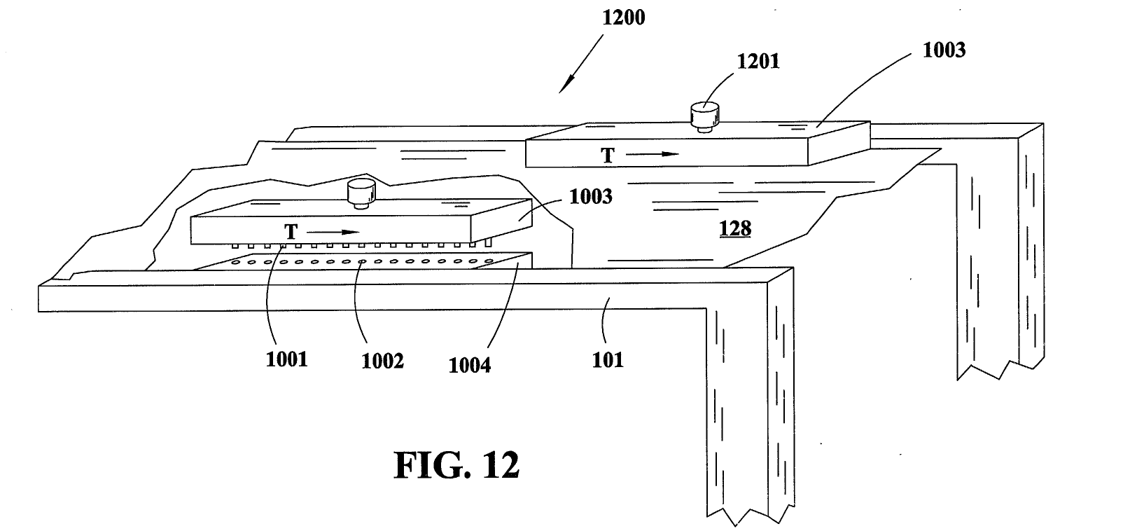

The stationary punch 1000 is illustrated in FIGS. 10 and 11. FIG. 10 is a cross sectional view illustrating the die 1004 and the punch 1003 having projections 1001. Apertures 1002 accept the projections 1001 and may be of varied sizes and shapes. Punched out material exits the die 1004 at the bottom of the apertures 1002.

Reference numeral 1200 illustrates the punches 1003 and the dies 1004 in position. The punches and dies may be indexed as indicated by the letter T which stands for translational movement of the dies at the same speed of the curtain. Operator 1201 represents diagrammatically the structure necessary to drive the punch 1003 into the die 1004.

It will be apparent to those skilled in the art that several changes may be made to the invention as disclosed herein without departing from the spirit and the scope of the appended claims.

We claim:

1. A method for manufacturing a flexible curtain utilizing a first polymeric sheet having first and second edges dispensed from a first roll, a second polymeric sheet having first and second edges dispensed from a second roll, and a woven substrate sheet having first and second edges dispersed from a third roll, a first and second laminating roll, a plurality of beveled rollers, a first and a second edge roller, comprising, the steps of:
laminating said first polymeric sheet, said second polymeric sheet and said woven substrate sheet together with said first and second laminating rolls;
folding said first and second edges of said first, second and woven sheets with said beveled rollers; and,
laminating said first and second edges of said curtain together with said first and second edge rollers.

2. A method for manufacturing a flexible curtain as claimed in claim 1 wherein the step of laminating said sheets together is performed under pressure of said laminating rolls.

3. A method for manufacturing a flexible curtain as claimed in claim 1 wherein the step of laminating said sheets together is performed with heated laminating rolls.

4. A method for manufacturing a flexible curtain as claimed in claim 1 wherein the step of laminating said sheets together is performed with heated laminating rolls under pressure.

5. A method for manufacturing a flexible curtain as claimed in claim 1 wherein a first perforating roller having protrusions thereon and a second perforating roller having apertures therein are utilized, further comprising the steps of:
perforating said folded edges of said flexible curtain.

6. A method for manufacturing a flexible curtain as claimed in claim 1 wherein an adhesive applicator is utilized, further comprising the steps of:
applying adhesive to one side of an edge as said beveled rollers form said folded edge.

7. A method for manufacturing a flexible curtain as claimed in claim 1 wherein said second edge roller includes a notch therein, and wherein said step of laminating said edges of said curtain together leaves a portion of said folded edge unlaminated.

8. A method for manufacturing a flexible curtain having a first edge and a second edge utilizing beveled rollers, a first edge roller having a shoulder thereon and a second edge roller having a shoulder thereon and a notch therein, comprising the steps of:
folding at least one of said edges of said curtain with said beveled rollers forming a folded edge portion of said curtain; and,
laminating and compressing said folded edge portion of said curtain by rolling said folded edge portion between said shoulders on said first and second edge rollers while leaving a strip of said folded edge portion unlaminated as it is not compressed between said first edge roller and said notch.

9. A method for manufacturing a flexible curtain as claimed in claim 8 wherein said step of folding includes folding both of said edges of said curtain and said step of laminating and compressing includes both of said edges of said curtain.

10. A method for manufacturing a flexible curtain as claimed in claim 8 utilizing an adhesive applicator, further comprising the step of:
applying adhesive to at least one edge of said curtain prior to folding said edge.

11. A method for manufacturing a flexible curtain as claimed in claim 8 wherein a first perforating roller having protrusions thereon and a second perforating roller having apertures therein are utilized, further comprising the steps of:
perforating said folded edge portion of said curtain.

12. A method for manufacturing a flexible curtain as claimed in claim 8 wherein a stitching apparatus is utilized, further comprising the step of:
stitching said folded and laminated edge portion.

13. A method for manufacturing a flexible curtain as claimed in claim 8 wherein an ultrasonic welding apparatus is utilized, further comprising the step of:
welding said folded and laminated edge portion.

14. A method for manufacturing a flexible curtain, comprising the steps of:
folding the edges of said curtain; and,
laminating a portion of said folded edges of said curtain together leaving the remaining portion of said folded edges of said curtain unlaminated.

15. A method for manufacturing a flexible curtain as claimed in claim 14 further comprising the step of:
sewing said laminated portion of said curtain.

16. A method for manufacturing a flexible curtain as claimed in claim 14 further comprising the step of:
punching apertures in said laminated portion of said folded edge.

17. A method for manufacturing a flexible curtain as claimed in claim 14 further comprising the step of:
applying adhesive to said edges of said curtain prior to folding said edges.

18. A method for manufacturing a flexible curtain as claimed in claim 14 further comprising the step of:
sewing said laminated portion of said curtain together.

19. A method for manufacturing a flexible curtain comprising the steps of:
folding the edges of said curtain; and,
welding a portion of said folded edges of said curtain together leaving the remaining portion of said folded edges of said curtain unwelded.

20. A method for manufacturing a flexible curtain as claimed in claim 19, comprising the steps of:
punching apertures in said welded portion of said folded edge.

21. A method for manufacturing a flexible curtain, comprising the steps of:
laminating a portion of strips of polymeric material along the edges of a polymeric substrate.

22. A method for manufacturing a flexible curtain as claimed in claim 21, further comprising the steps of:
welding, ultrasonically, a portion of said strips of polymeric material along the edges of a polymeric substrate.

23. A method for manufacturing a flexible curtain as claimed in claim 21, further comprising the steps of:
punching apertures in said strips and said substrates.

24. A method for manufacturing a flexible curtain as claimed in claim 22, further comprising the steps of:
punching apertures in said strips and said substrates.

25. A method for manufacturing a flexible curtain as claimed in claim 24 wherein said apertures are punched by a rotary punch.

26. A method for manufacturing a flexible curtain as claimed in claim 24 wherein said apertures are punched by a stationary punch.

27. A method for manufacturing a flexible curtain as claimed in claim 24 wherein said apertures are punched by an indexing punch.

28. A method for manufacturing a flexible curtain as claimed in claim 16 wherein said apertures are punched with a rotary punch.

29. A method for manufacturing a flexible curtain as claimed in claim 16 wherein said apertures are punched with a stationary punch.

30. A method for manufacturing a flexible curtain as claimed in claim 16 wherein said apertures are punched with an indexing punch.

31. An apparatus for making a flexible curtain, said flexible curtain having edges, comprising:
a plurality of beveled rollers for folding the edges of said flexible curtain and forming folded edges;
a first laminating edge roller;
a second laminating edge roller;
said second laminating edge roller includes a notch therein; and,
said folded edges of said flexible curtain passing between said laminating edge rollers laminating a portion of said folded edge to itself while leaving the remaining portion of said folded edge unlaminated.

32. An apparatus for making a flexible curtain as claimed in claim 31 further comprising:
a rotary punch for perforating said laminated portion of said folded edge.

33. An apparatus for making a flexible curtain as claimed in claim 31 further comprising:
a capacitance station and a stationary punch for perforating said laminated portion of said folded edge.

34. An apparatus for making a flexible curtain as claimed in claim 32 further comprising:
an indexing punch.

35. An apparatus for making a flexible curtain as claimed in claim 31 further comprising:
a stitching apparatus for reinforcing said laminated portion of said folded edge to itself.

36. An apparatus for making a flexible curtain as claimed in claim 31 further comprising:
an ultrasonic welding apparatus for reinforcing said laminated portion of said folded edge to itself.

37. An apparatus for making a flexible curtain as claimed in claim 31, further comprising:
an adhesive applicator for applying adhesive to said flexible curtain prior to said folding of said edges of said curtain.

38. An apparatus for making a flexible curtain, said flexible curtain having edges, comprising:
a strip of polymeric material;
a first laminating edge roller;
a second laminating edge roller;
said second laminating edge roller includes a notch therein; and,
said first and second laminating edge rollers laminate a portion of said strip of polymeric material to said edges of said flexible curtain leaving the remainder of said strip not laminated to said flexible curtain.

39. An apparatus for making a flexible curtain as claimed in claim 38 further comprising:
an adhesive applicator for securing said strip of polymeric material to said edge of said curtain.

40. An apparatus for making a flexible curtain as claimed in claim 38 further comprising:
a stitching apparatus for securing said strip of polymeric material to said edge of said curtain.

41. An apparatus for making a flexible curtain as claimed in claim 38 further comprising:
an ultrasonic welding apparatus for securing said strip of polymeric material to said edge of said curtain.

42. An apparatus for making a flexible curtain as claimed in claim 38 further comprising:
a rotary punch and a rotary die.

43. An apparatus for making a flexible curtain as claimed in claim 38 further comprising:
a capacitance station for storing said curtain having folded edges; and,
a stationary punch and die.

44. An apparatus for making a flexible curtain as claimed in claim 38 further comprising:
an indexing punch and die.
